(19) United States
(12) Patent Application Publication
(10) Pub. No.: US 2014/0263098 A1
(43) Pub. Date: Sep. 18, 2014

(54) RESIDENTIAL WATER TREATMENT SYSTEM FOR REMOVAL OF 1,4 DIOXANE AND ASSOCIATED COMPOUNDS AND METHOD OF USING SAME

(71) Applicants: Richard Abrams, Westborough, MA (US); William B. Kerfoot, Falmouth, MA (US)

(72) Inventors: Richard Abrams, Westborough, MA (US); William B. Kerfoot, Falmouth, MA (US)

(21) Appl. No.: 14/212,483

(22) Filed: Mar. 14, 2014

Related U.S. Application Data
(60) Provisional application No. 61/793,303, filed on Mar. 15, 2013.

(51) Int. Cl. C02F 1/78

(52) U.S. Cl. CPC C02F 1/78
USPC 210/760; 210/192; 210/188

(57) ABSTRACT

The disclosure provides apparatuses and methods for the reduction of the concentration of contaminants in residential drinking water. The apparatuses and methods described herein are capable of lowering the concentration of 1,4 dioxane found in well water to well below the state mandated maximum concentrations.

### RELATED APPLICATION

This application claims priority from U.S. Provisional Patent Application No. 61/793,303, filed on Mar. 15, 2013, which is incorporated by reference, herein, in its entirety.

### BACKGROUND OF THE INVENTION

The compound 1,4 dioxane, is suspected of causing cancer when present in small concentrations in drinking water supplies. Various states have placed maximum concentration limits (MCLs) on the compound for residential as well as municipal drinking water supplies. The Northeast region, Florida, Missouri, and California have dropped the standards for 1,4 dioxane to 3 ppb and Massachusetts has recently reduced the limit to 0.3 ppb. Several states are discussing lowering the levels to 1 ppb, pending EPA current studies.

The treatment of residential home and small public well water systems present some formidable challenges. First of all, the flow may not be constant but intermittent at best, ranging in a home from 1 to 8 gallons per minute (gpm) when the well is operated. Depending upon the designated use within the house, i.e., shower, laundry, cooking, sink, or toilet water, etc., the flow demand is variable. It is not uncommon to have a mean daily flow under 0.3 gpm when the total use is 300 gpd spread over 1,440 minutes each day for a three-person (two adults, one child) residence.

Secondly, the compound 1,4 dioxane, is very resistant to bacterial degradation. It also has a bond structure which normally requires a chemical reactant possessing a high oxidation potential to break apart the carbon-oxygen bonds, has been necessary for treating 1,4 dioxane.

1,4 dioxane is not only a persistent organic pollutant, but since it is highly soluble, it is also highly mobile in groundwater and forms long plumes which are often significantly advanced from the leading edge of a chlorinated solvent plume. Certain volatile organic compounds (VOCs) such as trichloroethane (TCA) and trichloroethene (TCE) are often co-contaminants of 1,4 dioxane. In the 2006 U.S.G.S. study of 1,208 domestic water well supplies, 1,4 dioxane along with 1,1,1-TCA, 1,1-dichloroethane, and 1,1-dichloroethene (as potential co-contaminants) were found in as many as 102, 16, and 19 wells respectively. Although many of the chlorinated compounds are volatile and can be air stripped, 1,4 dioxane cannot.

Treatability for residential home and small public wells is often far more constrained by cost than large-scale municipal wells. Advanced oxidation technologies employed ex-situ, such as ozone peroxidation, ultraviolet oxidation, and catalyzed photo-oxidation carry a high capital and operating cost. Owners of private wells affected by 1,4 dioxane may also be sufficiently separated from municipal supplies that they cannot be connected at reasonable costs.

For instance, Bowman (2002) found that ozone plus peroxide introduced as a liquid reactant was capable of rapid removal of 1,4 dioxane. We differ from Bowman in the introduction of ozone micro to nano-bubbles, introducing the ozone gas at right angles to flow, not requiring peroxide. The system described herein can deal with interruptions in flow, which Bowman cannot.

There exists a need for treatment system for intermittent water flow water use that removes 1,4 dioxane and other pollutants from water.

### SUMMARY

The disclosure provides an apparatus including an ozone micro or nano-bubble generator in fluid communication with an inlet conduit, wherein the inlet conduit comprises a first end and a second end, wherein the first end is in fluid communication with a water source and wherein the second end is in fluid communication with a pressure vessel and wherein the ozone micro or nano-bubble generator is positioned between the first and second end of the inlet conduit. In one embodiment, the ozone micro or nano-bubble generator includes an ozone gas source and a nanoporous material, wherein the ozone gas passes from the ozone gas source, through the nanoporous material and into the aqueous solution, thereby forming ozone micro or nano-bubbles. The ozone gas source can be an ozone gas generator.

In another embodiment, the apparatus also includes a liquid outlet conduit comprising a first end and a second end wherein the pressure vessel is in fluid communication with the first end of the liquid outlet conduit wherein the water from the water source flows from the inlet conduit into the pressure vessel and to the liquid outlet conduit. The liquid outlet conduit can include an ozone removal device. In certain aspects of this embodiment, the ozone removal device is selected from an activated carbon chamber or a shallow tray air stripper. The ozone removal device can also include an ozone removal tank. In certain aspects of this embodiment, the ozone removal tank stores aqueous solution that has passed through the pressure vessel and has been exposed to the ozone removal device.

In another embodiment, the pressure vessel further comprises a gas outlet conduit, which allows for flow of gas from the pressure vessel to the atmosphere while maintaining the pressure vessel at a pressure above atmospheric pressure.

In yet another embodiment, the ozone removal apparatus further comprises a vent to the atmosphere. The vent to the atmosphere can also join with the gas outlet conduit, described above. In certain aspects of this embodiment, the gas outlet conduit further comprises a catalyst that catalyzes the reaction of ozone to oxygen.

In other embodiments, the apparatus also includes a stripper that reduces the concentration of halogenated volatile organic compounds. The halogenated volatile organic compounds can be selected from tetrachloroethylene, vinyl chloride trichloroacetic acid, trichloroethylene, dichloroacetic acid and dichloroethylene. In certain aspects of this embodiment, the stripper is located upstream of the ozone micro or nano-bubble generator.

The disclosure also provides a method of reducing the concentration of a contaminant in an aqueous solution to be transmitted to a continuous or intermittent flow system including the step of passing the aqueous solution through the apparatus described above. In certain embodiments, the contaminant is 1,4 dioxane or methyl tert-butyl ether (MTBE) or ter butyl alcohol (TBA). In another embodiment, the contaminant is a one or more halogenated volatile organic compounds (HVOCs). The one or more HVOCs can be selected from vinyl chloride, tetrachloroethylene (PCE) trichloroacetic acid (TCA), trichloroethylene (TCE), dichloroacetic acid (DCA), and dichloroethylene (DCE).

In other embodiments, the aqueous solution passes the micro or nano-bubble generator with a shearing velocity of between 1,000 and 10,000 cc per min cm². In another embodiment, the ozone gas is injected into the aqueous solution at a 70° and a 110° angle between the direction of flow of the ozone gas and the direction of flow of the aqueous solution. In yet another embodiment, the aqueous solution and ozone gas are at a pressure of between 5 and 100 psig.

In certain other embodiments, the ozone treated aqueous solution is held in the pressure vessel until the amount of contaminant has been reduced in the aqueous solution. The ozone treated aqueous solution can be held in the pressure vessel for between 5 and 1440 minutes.

In yet another embodiment, the micro or nano-bubbles have diameters of between 0.1 and 200 μm. In certain embodiments, micro-bubbles have diameters of between 10 and 200 μm and nano-bubbles have diameters of between 0.1 and 10 μm. In another embodiment, the ozone removal device reduces the concentration of 1,4 dioxane in the aqueous solution. The nano-bubbles can include peroxide or they can be substantially free of peroxide when they are emitted into the aqueous solution.

In other embodiments, the flow system is a residential flow system with less than 200, 300 or 400 gallons per day of water. In other embodiments, the residential flow system provides 1-400, 10-400, 100-400, 200-400, 300-400, 1-100, 10-100, 1-200, 10-200, 100-200, 1-300, 10-300, or 100-300 gallons per day of water.

### BRIEF DESCRIPTION OF THE DRAWINGS

FIG. 1 shows side and end views of a conical micro or nano-bubble generator.

FIG. 2 is a flow chart describing an apparatus and method for removing 1,4 dioxane from an aqueous solution.

FIG. 3 is a schematic showing various angles and how they are arranged in relation to a direction of flow in an aqueous solution.

FIG. 4 is a flow chart describing an apparatus and method for removing 1,4 dioxane from an aqueous solution.

FIG. 5 is a schematic showing an embodiment of an apparatus described herein.

FIG. 6 is a schematic showing an embodiment of an apparatus described herein.

FIG. 7 is a schematic showing features of dissolved ozone and micro or nano-bubbles of ozone.

FIG. 8 is a line graph showing concentrations of 1,4 dioxane over time after treatment with air or ozone micro or nano-bubbles with and without peroxide.

FIG. 9 is a line graph showing concentrations of MTBE over time after treatment with air or ozone micro or nano-bubbles.

### DETAILED DESCRIPTION

The disclosure provides apparatuses and methods for reducing the concentration of 1, 4 dioxane in aqueous solution. In preferred embodiments, the aqueous solution is drinking water. Typically, drinking water is not pure, but contains various salts and other contaminants. Contaminants could include landfill run off or industrial waste water. The disclosure further describes apparatuses and methods for removing 1,4 dioxane from water used in continuous or intermittent flow systems. The disclosure provides apparatuses and methods that supply ozone to the aqueous solution to remove 1,4 dioxane. In certain embodiments, the ozone is provided in the form of micro or nano-bubbles. In certain embodiments, the micro or nano-bubbles are coated in peroxide. In other embodiments, the ozone micro or nano-bubbles contain little or no peroxide. The disclosure provides apparatuses that create ozone micro or nano-bubbles in flowing water and hold the water in a tank for 1,4 dioxane treatment. The treated water can then be subsequently treated for the removal of ozone. Other treatment systems can also be combined with the apparatuses described herein.

In certain embodiments, the water produced according to the apparatuses and methods described herein produce water with less than 1 μg/L (ppb) 1,4 dioxane. In other embodiments, the apparatuses and methods described herein treat aqueous solutions so that they contain less than 0.3 μg/L (ppb) of 1,4 dioxane. In certain embodiments, the apparatuses and methods described herein treat aqueous solutions so that they contain less than 0.1, 0.2, 0.3, 0.4, 0.5, 0.6, 0.7, 0.8, 0.9, 1, 5, 10, 15, 20, 25, 30, 35, 40, 45, 50, 55, 60, 65, 70, 75, 80, 85, 90, 95 or 100 μg/L (or ppb) of 1,4 dioxane.

### I. Continuous and Intermittent Flow Systems

In specific embodiments, the apparatuses and methods disclosed herein are designed for use with continuous or intermittent flow systems. These systems include residential and certain commercial water systems. In certain embodiments, these systems provide water for drinking, cooking, sanitation and/or home or simple commercial maintenance. Drinking water is includes providing potable water for humans, including infants, toddlers, children, teenagers, adults and the elderly as well as potable water for pets including dogs, cats, rodents and livestock. Sanitation includes the use of toilets, showers, laundry machines, dishwasher machines, bathtubs, sinks or hoses for personal, pet or livestock hygiene. Home or simple commercial maintenance includes house, hotel, hospital or community space cleaning, plant watering and care, vehicle washing and outdoor power washing.

As used herein, an intermittent flow system is a system in which the aqueous flow has a lowest flow rate that is at most 50% of the highest flow rate in a 24 hour period. In other embodiments, an intermittent flow system has an aqueous flow that has a lowest flow rate that is at most 45, 40, 35, 30, 25, 20, 15, 10, 5, 4, 3, 2 or 1% of the highest flow rate in a 24 hour period. In certain embodiments, the 24 hour periods referred to above are those 24 hour periods where total flow is greater than 1, 2, 3, 4, 5, 6, 7, 8, 9, 10, 20, 30, 40, 50, 60, 70, 80 90 or 100 gallons a day. In certain embodiments, residences, for example, are left idle for days at a time. During these idle times the aqueous flow during any 24 hour period can be low or substantially zero. However, when the intermittent systems are in use, they have uneven flow as described above.

In other embodiments, the flow in an intermittent flow system has an average rate of flow per day that is less than two times less than the maximum flow per minute in a 24 hour period on days when the intermittent flow system is in use. In other embodiments, an intermittent flow system has an average rate of flow per day that is less than 3, 4, 5, 6, 7, 8, 9, 10, 11, 12, 13, 14, 15, 16, 17, 18, 19, 20, 21, 22, 23, 24, 25, 26, 27, 28, 29, 30 times less than the maximum flow per minute in a 24 hour period on days when the intermittent flow system is in use when the total flow is less than 1, 2, 3, 4, 5, 6, 7, 8, 9, 10, 20, 30, 40, 50, 60, 70, 80 90 or 100 gallons a day.

Continuous flow systems are systems that do not have intermittent flow. In certain embodiments, continuous flow systems have flow rates of 1-400 gpm. In other embodiments, continuous flow systems have flow rates of 5-100 gpm. In other embodiments, continuous flow systems have flow rates of 10-200, 50-150, 100, 200, 100-300, 200-300, 100-400, 200-400 or 300-400 gpm. These systems include residential, industrial and certain commercial water systems.

In other embodiments, the flow system is a residential flow system with less than 200, 300 or 400 gallons per day of water. In other embodiments, the residential flow system provides 1-400, 10-400, 100-400, 200-400, 300-400, 1-100, 10-100, 1-200, 10-200, 100-200, 1-300, 10-300, or 100-300 gallons per day of water. In other embodiments, the flow system is a residential flow system with a design minimal flow of 200, 300, 330, or 400 gallons per day of water.

### II. Ozone Micro or Nano-Bubbles

In certain embodiments, 1,4 dioxane is removed from aqueous solutions described herein by exposing the aqueous solution to gaseous ozone. In certain embodiments, the aqueous solution is exposed to gaseous ozone, wherein the ozone is present as micro or nano-bubbles in the aqueous solution. As used herein, “nano-bubbles” refer to bubbles that are between 0.1 and 10 microns in diameter or a population of bubbles with an average diameter between 0.1 and 10 microns. As used herein, “micro-bubbles” refer to bubbles that are between 10 and 200 microns in diameter or a population of bubbles with an average diameter between 10 and 200 microns. In certain embodiments, nano-bubbles are 0.1-1, 1-5 or 5-10 μm in diameter or average diameter. In other embodiments, nano-bubbles are about 0.1-0.5, 0.5-1, 1-2, 2-3, 3-4, 4-5, 5-6, 6-7, 7-8, 8-9 or 9-10 μm diameter or average diameter. In other embodiments, nano-bubbles are about 0.1, 0.2, 0.3, 0.4, 0.5, 0.6, 0.7, 0.8, 0.9, 1, 2, 3, 4, 5, 6, 7, 8, 9 or 10 μm in diameter or average diameter. In certain embodiments, micro-bubbles are 10-20, 20-30, 30-40, 40-50, 50-60, 60-70, 70-80, 80-90, 90-100, 100-110, 110-120, 120-130, 130-140, 140-150, 150-160, 160-170, 170-180, 180-190, 190-200, 10-50, 10-100, 50-100, 100-200, 100-150 or 150-200 μm in diameter or average diameter. In other embodiments, micro-bubbles are aboot 10, 20, 30, 40, 50, 60, 70, 80, 90, 100, 110, 120, 130, 140, 150, 160 170, 180, 190 or 200 μm in diameter or average diameter.

Nanobubble ozone and methods of application were described in U.S. Patent Publication No. 2008/0061006. In certain embodiments, nanobubble-sized ozone was created by shearing the surface of nano-sized diffusers. Stable nanobubble emulsions are generated in water because of the negative-charged surface.

In certain embodiments, hydrogen peroxide can be added to the ozone to create peroxide coated ozone micro or nano-bubbles. Methods of creating such bubbles are described in U.S. Patent Publication No. 2011/0241230, incorporated by reference herein in its entirety. Peroxide coated ozone micro or nano-bubbles can be created by injecting hydrogen peroxide with the gaseous ozone formed into nano-bubbles.

In other embodiments, hydrogen peroxide is not added when creating micro or nano-bubbles. For residential homes, often the occupant does not wish to replenish or handle peroxide. Peroxide supply is therefore an optional use. In situations where an aqueous solution contains substantial organics or elevated chromium peroxide could be used. In certain embodiments, Perozone® (peroxide/ozone) is used. Otherwise, ozone alone would be used to create the micro or nano-bubble supply for treatment of the 1,4 dioxane.

This can mean that the apparatus introducing the micro or nano-bubbles of ozone to the aqueous solution is not also adding hydrogen peroxide to the ozone. This can also mean that hydrogen peroxide is not added to the aqueous solution during the process that removes 1,4 dioxane from the water. This can also mean that hydrogen peroxide is not added to an aqueous solution from when it is pumped from a water source until it is provided as purified water to a consumer. In residential systems, it can be disadvantageous for consumers to deal with hydrogen peroxide. Further, as explained below, ozone micro or nano-bubbles without peroxide coating are effective in removing 1,4 dioxane from aqueous solution.

In some embodiments, when peroxide is added, approximately 7 gallons of 8% solution of hydrogen peroxide is used per day for 252,000 gallons of aqueous solution. In other embodiments, less than 7 gallons of 8% solution of hydrogen peroxide is used per 252,000 gallons of aqueous solution. In certain embodiments, 0.1, 0.2, 0.3, 0.4, 0.5, 0.6, 0.7, 0.8, 0.9, 1, 2, 3, 4, 5 or 6 gallons of 8% solution of hydrogen peroxide is used per 252,000 gallons of aqueous solution.

The micro or nano-bubble generators to feed the pressure vessel operate under pressure (5 to 100 psig, as explained below). Two embodiments of micro or nano-bubble generators include 1) a Spargepoint® including nanoporous material and a circulator increasing the velocity across the surface to achieve a minimum shear velocity, and (See FIG. 1).

In certain embodiments, ozone is injected into the flow stream at approximately right angles to the flow. The shearing velocity of 1,000 to 10,000 cc per min cm² across a stainless steel porous tube with a porosity of 50 to 200 nm, results in bubble sizes being produced (in 40 psi conditions) of 0.15 to 10 microns, appearing as a milky condition while suspended in the water. The volume of bubbles exceeds 1×10⁶ (one million) per liter. Micro or nano-bubble generators are described in greater detail below.

If the 1,4 dioxane concentration is very high, the water flow can be “looped” back through the inflow tube containing the micro or nano-bubble generator multiple times using a separate pump. The extent of looping or recycling through the generator will be determined by what is necessary to reach the desired concentration of 1,4 dioxane for the aqueous solution.

### III. Apparatus

The disclosure provides an apparatus for applying gaseous ozone to a flow of aqueous solution to remove 1,4 dioxane from the solution. One embodiment of the apparatus is demonstrated in the flow chart shown in FIG. 2. FIG. 2 shows flow of an aqueous solution from a source into the apparatus. The source of water can be any source appropriate for a continuous or an intermittent flow system. Examples of residential sources include wells.

Optionally, the apparatus may include a device for the removal of dissolved iron or other metals. In certain embodiments, the device for removal of dissolved iron or other metals is placed between the water source and the remainder of the apparatus. However, the may be placed at any position in the apparatus that is appropriate for the removal of dissolved iron or other metals.

The apparatus can also include a stripper that removes elevated concentrations of chlorinated compounds. The treatment sequence can be switched around for elevated concentrations of chlorinated compounds accompanying the 1,4 dioxane. If the intermittent flow system is far from the source (distant downgradient), it may only be affected by 1,4 dioxane. However, as the water source is positioned closer to the source of contamination, it is common to observe increasing concentrations of halogenated volatile organic compounds (HVOCs) (like vinyl chloride, tetrachloroethylene (PCE) trichloroacetic acid (TCA), trichloroethylene (TCE), dichloroacetic acid (DCA), and dichloroethylene (DCE)) accompanying the 1,4 dioxane contamination. In this case, if the HVOC total exceeds the 1,4 dioxane mass by more than ten times, the stripper can be positioned in front of the micro or nano-bubble ozone injector and associated pressure vessel. The stripper can remove certain HVOCs, like TCE and DCA, more efficiently than ozone treatment, requiring less ozone mass which is better used to remove the 1,4 dioxane quantitatively.

As the aqueous solutions flows from the water source into the apparatus, it encounters an ozone water bubble generator. Several embodiments of such generators are described in U.S. Patent Publication No. 2011/0241230, incorporated by reference herein in its entirety. Micro or nano-bubbles are generated by introducing ozone gas to flowing water at angles non-parallel to the flow of the aqueous solution. In certain embodiments, the flow of ozone gas is perpendicular to the flow of the aqueous solution, i.e. is at a 90° angle from the flow of the water. The reason for the perpendicular injection is to use the velocity of the water to shear off the ozone bubbles and form smaller bubbles. In other embodiments, the direction of the flow of ozone gas is between a 45° and an 89° angle from the flow of ozone gas. In other embodiments, the flow of ozone gas is between a 91° and a 135° angle from the flow of ozone gas. The directions of these angles of flow are shown in FIG. 3. In other embodiments, the flow of ozone gas is between a 70° and a 110° angle, 75° and a 105° angle, 80° and a 100° angle, 85° and a 95° angle from the flow of ozone gas.

In certain embodiments, the ozone gas is injected into the flow of aqueous solution at a pressure of between 5 and 100 psi. In other embodiments, the ozone gas is injected into the flow of aqueous solution at a pressure of between 10 and 90, 20 and 80, 20 and 70, 20 and 60 20 and 50, 30 and 50 or 40 and 50 psi. The aqueous solution can be flowed past the ozone gas at a shearing velocity of 1,000 to 10,000 cc per min cm². This shearing coupled with the pressure of the ozone gas creates micro or nano-bubbles. In other embodiments, the aqueous solution can be flowed past the ozone gas at a shearing velocity of 1,000 to 2,000; 2,000 to 3,000; 3,000 to 4,000; 4,000 to 5,000; 5,000 to 6,000; 6,000 to 7,000; 7,000 to 8,000; 8,000 to 9,000 or 9,000 to 10,000 cc per min cm².

The zone in which the ozone gas is injected into the aqueous solution can use reverse venturi, venturi, loop, or side-by stream loop arrangements as described in U.S. Patent Publication No. 2011/0241230, incorporated by reference herein in its entirety. As explained above, the micro or nano-bubbles can be peroxide coated or without peroxide coating. Thus, the ozone gas injection system can also add hydrogen peroxide to the aqueous solution or additional hydrogen peroxide can be absent from the ozone gas injection system.

After the aqueous solution is treated with ozone micro or nano-bubbles it proceeds to a pressure vessel. The ozone treated aqueous solution is held under pressure in the vessel to enhance the amount of 1,4 dioxane that is removed. The pressure in the pressure vessel can be between 5 and 100 psi. In other embodiments, the pressure vessel has a pressure of between 10 and 90, 20 and 80, 20 and 70, 20 and 60 20 and 50, 30 and 50 or 40 and 50 psi. The ozone treated aqueous solution can be held in the pressure vessel for a period of time that allows for enhancement of the removal of 1,4 dioxane. The ozone treated aqueous solution can be held in the pressure vessel for 5 to 1440 minutes. In other embodiments, the ozone treated aqueous solution can be held in the pressure vessel for 10 to 600, 20 to 540, 30 to 480, 40 to 420, 50 to 360, 60 to 300, 60 to 240, 60 to 180 or 60 to 120 minutes.

According to the embodiment described in FIG. 2, the pressure vessel also includes a gas outlet that allows for ozone or oxygen that comes out of suspension or solution to be expelled from the pressure vessel. In certain embodiments, the ozone that is released from the pressure vessel through the gas outlet is treated with a catalyst that converts the ozone to oxygen that is released to the outside.

According to the embodiment described in FIG. 2, the pressure vessel also includes a liquid outlet that allows treated aqueous solution to flow to an ozone removal device. The ozone removal device can include activated carbon or it could be a shallow tray air stripper. However, any method known in the art can be used to remove the ozone from the aqueous solution. From the ozone removal device, the aqueous solution can then be used for residential and certain commercial uses. In certain embodiments, the ozone removal device provides a back up for 1,4 dioxane removal. In these embodiments, the ozone removal device includes activated carbon. For example, the ozone removal device can provide a period of time for removal of the 1,4 dioxane by activated carbon in the event the ozone generator is being repaired.

Another embodiment of the apparatus described herein is disclosed in the flow chart shown in FIG. 4. In this embodiment, a shallow tray stripper is placed upstream of the position where the ozone gas is introduced to the aqueous solution. The shallow tray stripper can be placed upstream or downstream of the device for the removal of dissolved iron or other metals, if that device is present. In certain embodiments, the shallow tray stripper removes certain volatile organic compounds (VOCs). These VOCs can include trichloroethane (TCA) and trichloroethene (TCE), which are often co-contaminants of 1,4 dioxane. VOCs also include 1,1,1-TCA, 1,1-dichloroethane, and 1,1-dichloroethene.

Another specific embodiment is shown in FIG. 5. In this embodiment a 4 gm/hr ozone generator provides ozone gas under pressure to a micro or nano-bubble ozone generator, which adds the fine bubbles into the water stream. In certain embodiments, the ozone generator can produce 4 gm/hr of ozone gas. In other embodiments, the ozone generator can produce 0.2-10 gm/hr of ozone gas. After passing the site of the ozone generator the water stream then travels to a pressure storage chamber or pressure vessel through a liquid inlet conduit (also referred to as an inlet conduit), which provides residence time for reactions to occur. The pressure storage chamber or pressure vessel, can have a 30 gallon capacity. In other embodiments, the pressure storage chamber or pressure vessel has a 5-500 gallon capacity. In other embodiments, the pressure storage chamber or pressure vessel has a 5-10, 10-20, 20-40, 20-50, 20-60, 60-80, 80-100, 100-150, 150-200, 250-300, 300-350, 350-400, 400-450 or 450-500 gallon capacity. Ozone gas trapped at the top of the pressure storage chamber or pressure vessel can be transferred via a gas outlet conduit to be delivered to a stripper vent. In certain embodiments, the ozone is passed through a catalyst, which transforms O₃ to O₂ in the stripper vent. Liquid from the pressure storage chamber or pressure vessel flows through a liquid outlet conduit into a device to remove excess ozone before the water is used in the home. One method is to use an shallow tray air stripper, which has air pumped through the water on the tray to remove any residual ozone gas bubbles and remaining VOCs. A booster pump returns the flow to the home piping system. Alternatively, the preferred method is for the water from the pressure tank to flow to a container of activated carbon which serves to remove residual dissolved ozone and also serve to provide a period of time for removal of the 1,4 dioxane by activated carbon in the event the ozone generator is being repaired. In certain embodiments, no booster pump is needed with the activated carbon unit, since it operates under line pressure. In either embodiment, the device to remove excess ozone also includes a storage vessel for holding ozone treated water until the treated water is to be used in the intermittent flow system. The storage vessel can hold 30 gallons. In other embodiments, the pressure storage chamber or pressure vessel has a 5-10, 10-20, 20-40, 20-50, 20-60, 60-80, 80-100, 100-150, 150-200, 250-300, 300-350, 350-400, 400-450 or 450-500 gallon capacity.

Certain embodiments use a micro or nano-bubble-sized laminar point positioned in an inlet tube to achieve critical shear velocities and maintain a pressure of 20 psi to 50 psi to the treated groundwater. Increasing the operation pressure to 40 to 50 psi is consistent with normal residential water pressures and would increase the rate of reaction to more than double the rate at the 5 psi bench scale test, described in the Examples below.

Another embodiment is shown in FIG. 6. The embodiment described in FIG. 6 includes an optional sediment filter. The embodiments shown in FIG. 5 or 6 could also include devices for pretreatment of dissolved iron at the front end of the flow. These devices can be selected from a variety of iron precipitators. The embodiment described in FIG. 6 also provides a flow meter between the sediment filter and ozone generator. One or more of these flow meters can be inserted at any point in the device that flow occurs and needs to be measured. For example, the flow meter could be positioned between the sediment filter and the supply pump, between the ozone generator and the pressure vessel between the pressure vessel and the air stripper (ozone removing device), between the air stripper and the downstream pump or between the downstream pump and the intermittent flow system. Further, one or more valves, pumps, pressure gauges and sample ports may be placed anywhere in the apparatus, including the positions shown in FIG. 6. Valves, pumps, pressure gauges and sample ports may be placed between the well and the supply pump, if present, between the well and the sediment filter, if present, between the well and the flow meter if present, between the well and the ozone generator, between the ozone generator and the pressure vessel, between the pressure vessel and the ozone removing device, between the ozone removing device and the downstream pump or between the downstream pump and the intermittent flow system.

One difference between the embodiment shown in FIG. 6 and FIG. 5 is the type of ozone removing device use. The embodiment shown in FIG. 5 uses activated carbon. The embodiment used in FIG. 6 uses an air stripper to remove ozone. The air stripper is vented to allow ozone to flow into the atmosphere. This vent can also allow gas that is released from the gas conduit outlet on the pressure vessel to escape the apparatus.

### EXAMPLES

The present invention is further illustrated by the following examples, which should not be construed as further limiting. The contents of and all references, patents and published patent applications cited throughout this application are expressly incorporated herein by reference.

### Example 1

### Bench Scale Testing

Gaseous ozone as nano or microbubbles was used as a reactant in a stirred flask reactor under pressure. Previous testing has shown that the kinetic reaction requires a pressure term (Kerfoot, 2010). Normal reactions were conducted in groundwater under a pressure of about 5 psi, representing the natural water head pressure of about 14 ft. of water (14 ft.×0.42=5.8 psi).

Two tests were run. First, ozone and oxygen alone were used. A microporous laminar point was used to create ozone nano or microbubbles of about 10-50 microns in diameter. For the second test, hydrogen peroxide was supplied to the point to create coated nano or microbubbles with hydrogen peroxide. Schematics of dissolved ozone and peroxide coated ozone micro or nano-bubbles are provided in FIG. 7. A reaction vessel contained two liters of groundwater, holding 1,4 dioxane (mass of 88.11 g/mol) at a concentration of 5,000 μg/L. After 480 minutes, the concentration was reduced to 1,100 μg/L, indicating a removal of about 78% mass. In this test, peroxide was also added at 5% concentration (mass of 34 g/mol). The mass of ozone was 6.9 millimoles and peroxide 706 millimoles (in excess). Very little difference in removal efficiency occurred between microbubble to nano-bubble ozone and ozone plus peroxide.

A second set of tests was run with a solution using MTBE as a tracer compound. A similar setup was used in the laboratory bench scale testing as before. The differences were that the reactor contained three liters for testing, allowing more sampling.

For these samples, an independent laboratory (Alpha Analytical) ran duplicates of the samples taken. The removal rates were compared with start (0 minutes), midway (60 minutes), and final (120 minutes). (See FIG. 8). The results are also summarized in Table 1, below.

1,4 Dioxane Bench Scale Test Laboratory Results Operated at 5 psi. At 40 psi Reaction is Twice as Fast

| | Time Sampled After | 1,4 Dioxane | Percent | |
|---|---|---|---|---|
| Sample Name | start of test (mins) | Concentration (μg/L) (1) | Removal | Remarks |
| BT1-0 | 0 | 148 | 0.0 | Bench Test #1 - air only |
| BT1-60 | 60 | 158 | 5.8 | Bench Test #1 - air only |
| BT1-120 | 120 | 162 | −9.5 | Bench Test #1 - air only |
| BT2-0 | 0 | 119 | 0.0 | Bench Test #2 - ozone @ 1,000 ppmV |
| BT2-60 | 60 | 40.6 | 68.5 | Bench Test #2 - ozone @ 1,000 ppmV |
| BT2-120 | 120 | 8.8 | 93.2 | Bench Test #2 - ozone @ 1,000 ppmV |
| BT3-0 | 0 | 138 | 0.0 | Bench Test #3 - ozone @ 1,000 ppmV, Peroxide @ 3% |
| BT3-60 | 60 | 32.8 | 83.5 | Bench Test #3 - ozone @ 1,000 ppmV, Peroxide @ 3% |
| BT3-120 | 120 | 1.27 | 99.1 | Bench Test #3 - ozone @ 1,000 ppmV, Peroxide @ 3% |

Notes:
(1) = Alphalab Analytical (320 frobes Blud, Mansfield, MA 020 [symbol] ) laboratory results per FPA-8770 SIM method [symbol]
indicates data missing or illegible when filed

With air only being supplied, no removal of the 1,4 dioxane was observed. With ozone alone, 93.2% was observed with ozone at 1000 ppmV, dropping the starting concentration from 129 μg/L to 8.8 μg/L after 120 minutes. Here the addition of peroxide at 3% concentration along with the ozone at 1000 ppmV concentration resulted in a removal of 99.1% of the 1,4 dioxane. Since the starting value was reduced from 138 μg/L to 1.27 μg/L, below the standards of most states, the bench scale testing was deemed successful. MTBE, which was monitored on a separate HNU portable gas chromatograph, exhibited a reduction from 1000 μg/L to 50 μg/L, showing a removal of 95%, essentially tracking the 1,4 dioxane removal. This allowed us to run far quicker tests using MTBE as a surrogate compound for the 1,4 dioxane, speeding up testing of options.

Further tests were performed using MTBE as a marker for 1,4 dioxane. In these tests, ozone was injected at the indicated pressures and indicated water flow rates shown in Table 2.

Removal of MTBE Similar to 1,4 Dioxane
CLEARDIOXANE PILOY TESTS GC DATA AND REDUCTION
PAGE 1 OF 1

| | | | MINUTES | | | | |
|---|---|---|---|---|---|---|---|
| | | | ELPASED | | | | |
| | | | SINCE | | | | MASS |
| | DATE | | TEST | SAMPLE | | GC RESULTS | REDUCTIONS |
| TEST # | PERFROMED | ANALYSES# | BEGAN | NAME | ANALYTE | (PPB ug/L) | (%) |
| 1 | 18.AUG.2011 | [symbol] | 0 | T1-0 | MTBE | 1,160 | 0.0 |
| | | 3 | 20 | T1-20 | MTBE | 270 | 76.7 |
| 2 | 18.AUG.2012 | 1 | 0 | T2-0 | MTBE | 1,200 | 0.0 |
| | | 5 | 20 | T2-20 | MTBE | 480 | 60.0 |
| 3 | 18.AUG.2013 | 1 | 0 | T3-0 | MTBE | 1,160 | 0.0 |
| | | 2 | 20 | T3-20 | MTBE | 340 | 70.7 |
| 4 | [symbol] | 2 | 20 | | MTBE | 70 | 94.0 |

| | | | RELATIVE | | |
|---|---|---|---|---|---|
| TEST | DATE | | CONCENTRATIONS | | LIQUID:GAS |
| # | PERFROMED | ANALYSES# | C_{T}/C_{O} | REMARKS | RATIO |
| 1 | 18.AUG.2011 | [symbol] | 1.00 | TEST #1: OZONE @ 5.000 PPMV; | 5:1 |
| | | 3 | 0.23 | WATER FLOW 2 LPM; OZONE | |
| | | | | INJECT @ 400 ML/MINUTE | |
| 2 | 18.AUG.2012 | 1 | 1.03 | TEST #2: OZONE @ 5.000 PPMV; | 10:1 |
| | | 5 | 0.40 | WATER FLOW 4 LPM; OZONE | |
| | | | | INJECT @ 400 ML/MINUTE | |
| 3 | 18.AUG.2013 | 1 | 1.03 | TEST #3: OZONE @ 5.000 PPMV; | [symbol] |
| | | 2 | 0.20 | WATER FLOW 2 LPM; OZONE | |
| | | | | INJECT @ 2.000 ML/MINUTE | |
| 4 | [symbol] | 2 | 0.08 | Test #4 oxone @ 5000 ppmv, water | 1:1 |
| | | | | flow 2 LPM pressure 40 psi inject @ | |
| | | | | 2000 ml/minute | |

[symbol]

indicates data missing or illegible when filed

These results are also shown in FIG. 9. The laboratory bench scale testing was four-showed that peroxide-coated micro to nano-bubble ozone as well as uncoated nano-bubble ozone can rapidly remove 1,4 dioxane and MTBE in groundwater. With relatively clean water, nano-bubble ozone alone can remove 1,4 dioxane and MTBE from groundwater. Concentrations of 100 μg/L 1,4 dioxane can be reduced below 3 μg/L, suitable for drinking water MCLs. A simple nano-bubble ozone reaction chamber, followed by a multilayered stripper can remove 1,4 dioxane as well as chlorinated VOCs, and MTBE.

### REFERENCES

Abrams, R. and W. B. Kerfoot, 2012. Removing 1,4 Dioxane and MTBE in Residential Well Supplies. Presented at: The 22^{nd} Annual International Conference on Soils, Water, Energy and Air, San Diego, Calif.
Brolowski, A, 2005. In-Situ 1,4 Dioxane Remediation in HVOC Sites. Presented at: The 21^{st} Annual International Conference on Soils, Sediments and Water, University of Massachusetts, Amherst.
Dowideit, P. and C. V. Sonntag, 1996. Reaction of Ozone with Ethene and its Methyl and Chlorine-Substituted Derivatives in Aqueous Solution. Envir. Sci. Technol. 22:1112-1119.
Dyksen, et al., 1992. In-Line Ozone and Hydrogen Peroxide Treatment for Removal of Organic Chemicals, AWWA Research Foundation, 88 pp.
EPA, 2006. Treatment Technologies for 1,4 Dioxane, Fundamentals and Field Applications. Office of Solid Waste and Emergency Response, EPA-542-R-06-009, 33 pp.
Glaze, et al., 1988. Advanced Oxidations Processes for Treating Groundwater Contaminated with TCE and PCE: Laboratory Studies. Journal AWWA, pp. 57-63
Haas, C. N. and R. J. Vamos, 1995. Ozone and Advanced Oxidation Processes. In: Hazardous and Industrial Waste Treatment, Prentice Hall.
Karpel vel Leitner, et al., 1994. Oxidation of Methyl tert-Butyl Ether (MTBE) and Ethyl tert Butyl Ethel (ETBE) by Ozone and Combined Ozone/Hydrogen Peroxide. Ozone Science and Engineering, 16, pp. 41-54.
Kerfoot, W. B., 2010. In-Situ 1,4 Dioxane and VOC Remediation in HVOC Sites and Pumped Groundwater. International Ozone Association, PAG Conference, Seattle, Wash.
Mohr, T. K. G., 2012. Emerging Technologies: 1,4 Dioxane Occurrences and Treatment Options in Private Wells, EPA, Technology News and Trends.
Mokrini, D., et al., 1997. Oxidation of Aromatic Compounds with UV Radiation/Ozone/Hydrogen Peroxide. Wat. Sci. Tech., Vol. 35, No. 4, pp. 95-102.

### Patents of Reference

U.S. Pat. No. 5,851,407 Bowman et al. Process and Apparatus for Oxidation of Contaminants in Water, Applied
   Process Technology
U.S. Pat. No. 8,225,856 Kerfoot. Treatment of Recycled Fracture Water—Gas and Oil Recovery in Shale Deposits
U.S. Pat. No. 7,645,380 Kerfoot. Microporous Diffusion Apparatus
U.S. Pat. No. 7,264,747 Kerfoot. Coated Microbubbles for Treating an Aquifer or Soil Formations

What is claimed is:

1. An apparatus for removal of contaminants in residential well water drinking supplies comprising an ozone micro or nano-bubble generator in fluid communication with an inlet conduit, wherein the inlet conduit comprises a first end and a second end, wherein the first end is in fluid communication with a water source and wherein the second end is in fluid communication with a pressure vessel and wherein the ozone micro or nano-bubble generator is positioned between the first and second end of the inlet conduit, wherein the apparatus has a flow rate of less than 400 gallons per day and wherein the apparatus further comprises a dissolved ozone removal device.

2. The apparatus of claim 1, wherein the ozone micro or nano-bubble generator comprises an ozone gas source and a nanoporous material, wherein the ozone gas passes from the ozone gas source, through the nanoporous material and into the aqueous solution, thereby forming ozone micro or nano-bubbles.

3. The apparatus of claim 2, wherein the ozone gas is injected into the aqueous solution at a 70° and a 110° angle between the direction of flow of the ozone gas and the direction of flow of the aqueous solution.

4. The apparatus of claim 2, wherein the ozone gas source is an ozone gas generator.

5. The apparatus of claim 1, further comprising a liquid outlet conduit comprising a first end and a second end wherein the pressure vessel is in fluid communication with the first end of the liquid outlet conduit wherein the water from the water source flows from the inlet conduit into the pressure vessel and to the liquid outlet conduit.

6. The apparatus of claim 5, wherein the dissolved ozone removal device is an activated carbon chamber.

7. The apparatus of claim 1, further comprising a shallow tray air stripper.

8. The apparatus of claim 7, wherein the ozone removal device further comprises an ozone removal tank.

9. The apparatus of claim 8, wherein the ozone removal tank stores aqueous solution that has passed through the pressure vessel and has been exposed to the ozone removal device.

10. The apparatus of claim 1, where in the pressure vessel further comprises a gas outlet conduit that allows for flow of gas from the pressure vessel to the atmosphere while maintaining the pressure vessel at a pressure above atmospheric pressure.

11. The apparatus of claim 6, wherein the ozone removal apparatus further comprises a vent to the atmosphere.

12. The apparatus of claim 11, wherein the vent to the atmosphere joins with the gas outlet conduit.

13. The apparatus of claim 10, wherein the gas outlet conduit further comprises a catalyst that catalyzes the reaction of ozone to oxygen.

14. The apparatus of claim 1, further comprising a stripper that reduces the concentration of halogenated volatile organic compounds.

15. The apparatus of claim 14, wherein the halogenated volatile organic compounds are selected from the group consisting of tetrachloroethylene, vinyl chloride trichloroacetic acid, trichloroethylene, dichloroacetic acid and dichloroethylene.

16. The apparatus of claim 14, wherein the stripper is located upstream of the ozone micro or nano-bubble generator.

17. A method of reducing the concentration of a contaminant in an aqueous solution to be transmitted to a continuous or an intermittent residential flow system comprising passing the aqueous solution through the apparatus of claim 1.

18. The method of claim 17, wherein the contaminant is 1,4 dioxane or methyl tert-butyl ether (MTBE) or ter butyl alcohol (TBA).

19. The method of claim 17, wherein the contaminant is a one or more halogenated volatile organic compounds (HVOCs).

20. The method of claim 19, wherein the one or more HVOCs are selected from the group consisting of vinyl chloride, tetrachloroethylene (PCE) trichloroacetic acid (TCA), trichloroethylene (TCE), dichloroacetic acid (DCA), and dichloroethylene (DCE).

21. The method of claim 17, wherein the aqueous solution passes the micro or nano-bubble generator with a shearing velocity of between 1,000 and 10,000 cc per min cm².

22. The method of claim 21, wherein the ozone gas is injected into the aqueous solution at a 70° and a 110° angle between the direction of flow of the ozone gas and the direction of flow of the aqueous solution.

23. The method of claim 21, wherein the aqueous solution and ozone gas are at a pressure of between 5 and 100 psi.

24. The method of claim 17, wherein the ozone treated aqueous solution is held in the pressure vessel until the amount of contaminant has been reduced in the aqueous solution.

25. The method of claim 24, wherein the ozone treated aqueous solution is held in the pressure vessel for between 5 and 1440 minutes.

26. The method of claim 17, wherein the nano-bubbles have diameters of between 0.1 and 10 μm.

27. The method of claim 17, wherein the ozone removal device reduces the concentration of 1,4 dioxane in the aqueous solution.

28. The method of claim 17, wherein the micro or nano-bubbles comprise peroxide.

29. The method of claim 17, wherein the micro or nano-bubbles are substantially free of peroxide when they are emitted into the aqueous solution.
